(19) United States
(12) Patent Application Publication
(10) Pub. No.: US 2020/0075908 A1
(43) Pub. Date: Mar. 5, 2020

(54) BATTERY FASTENING STRUCTURE AND BATTERY FASTENING STRUCTURE ASSEMBLY INCLUDING THE SAME

(71) Applicant: Cheng Uei Precision Industry Co., Ltd., New Taipei City (TW)

(72) Inventor: JUNG-CHING CHENG, New Taipei City (TW)

(21) Appl. No.: 16/432,922

(22) Filed: Jun. 5, 2019

(30) Foreign Application Priority Data
Aug. 31, 2018 (CN) 201821435819.0

(51) Int. Cl. H01M 2/10; H01M 2/30

(52) U.S. Cl. CPC H01M 2/1083; B60L 50/66; H01M 2220/20; H01M 2/305

(57) ABSTRACT

A battery fastening structure includes a surrounding unit and two buckling boards. The surrounding unit includes a plurality of surrounding boards foldable to form a hollow tubular shape. Two opposite ends of the surrounding unit have two opposite connecting ends. The two buckling boards are folded towards the surrounding unit to be buckled to the two opposite connecting ends of the surrounding unit, so that the plurality of the surrounding boards are folded to form the hollow tubular shape, and an accommodating space is surrounded among the two buckling boards and the surrounding unit. An outer surface of the surrounding unit is equipped with a plurality of fastening elements. At least two surrounding units are buckled and integrated with each other by virtue of the plurality of the fastening elements of the at least two surrounding units being fastened with each other.

### CROSS-REFERENCE TO RELATED APPLICATION

The present application is based on, and claims priority form, China Patent Application No. 201821435819.0, filed Aug. 31, 2018, the disclosure of which is hereby incorporated by reference herein in its entirety.

### BACKGROUND OF THE INVENTION

### 1. Field of the Invention

The present invention generally relates to a battery fastening structure, and more particularly to a battery fastening structure, and a battery fastening structure assembly including the same capable of flexibly controlling a quantity of batteries which are assembled in the battery fastening structure assembly.

### 2. The Related Art

Nowadays, with rapid developments of industries of electric vehicles, electric tools, new energy automobiles and other electric devices in our country, requirements on lithium batteries are increased continuously. A conventional battery fastening structure is used for fastening the lithium battery, with the growth of the lithium batteries, it is especially important for the conventional battery fastening structure to be improved. Currently, a way of manufacturing a large capacity battery is achieved by virtue of connecting a large number of the lithium batteries, so the conventional battery fastening structure is disposed in the large capacity battery for fastening and protecting the lithium batteries. With the electric devices being different, designs of the lithium batteries will be changed accordingly.

However, the conventional battery fastening structure has no way of being flexibly adjusted with different designs of the lithium batteries, new battery fastening structures must be frequently manufactured again and again to cooperate with the different designs of the lithium batteries.

Thus an innovative battery fastening structure, and an innovative battery fastening structure assembly including at least two innovative battery fastening structures are especially important to be designed, the innovative battery fastening structure assembly is capable of flexibly controlling a quantity of batteries which are fastened in the innovative battery fastening structure assembly.

### SUMMARY OF THE INVENTION

An object of the present invention is to provide a battery fastening structure. The battery fastening structure includes a surrounding unit and two buckling boards. The surrounding unit includes a plurality of surrounding boards. The plurality of the surrounding boards are foldable to form a hollow tubular shape and connected. Two opposite ends of the tubular-shaped surrounding unit have two opposite connecting ends. The two buckling boards are disposed to a top end and a bottom end of the surrounding unit, respectively, and the two buckling boards are foldable with respect to the surrounding unit. The two buckling boards are folded towards a bottom surface and a top surface of the surrounding unit to be buckled to the two opposite connecting ends of the surrounding unit, so that the plurality of the surrounding boards are folded to form the hollow tubular shape, and an accommodating space is surrounded among the two buckling boards and the surrounding unit. An outer surface of the surrounding unit is equipped with a plurality of fastening elements. At least two surrounding units are buckled and integrated with each other by virtue of the plurality of the fastening elements of the at least two surrounding units being fastened with each other.

Another object of the present invention is to provide a battery fastening structure assembly. The battery fastening structure assembly includes at least two battery fastening structures for fastening at least two batteries. Each battery fastening structure includes a surrounding unit and two buckling boards. The surrounding unit includes a plurality of surrounding boards. The plurality of the surrounding boards are foldable to form a hollow tubular shape and connected. Two opposite ends of the tubular-shaped surrounding unit have two opposite connecting ends. The two buckling boards are disposed to a top end and a bottom end of the surrounding unit, respectively, and the two buckling boards are foldable with respect to the surrounding unit. The two buckling boards are folded towards a bottom surface and a top surface of the surrounding unit to be buckled to the two opposite connecting ends of the surrounding unit, so that the plurality of the surrounding boards are folded to form the hollow tubular shape, and an accommodating space is surrounded among the two buckling boards and the surrounding unit. An outer surface of the surrounding unit is equipped with a plurality of fastening elements. At least two surrounding units of the at least two battery fastening structures are buckled and integrated with each other by virtue of the plurality of the fastening elements of the at least two surrounding units of the at least two battery fastening structures being fastened with each other.

Another object of the present invention is to provide a battery fastening structure assembly. The battery fastening structure assembly includes at least two battery fastening structures for fastening at least two batteries. Each battery fastening structure includes a surrounding unit and two buckling boards. The surrounding unit includes a plurality of surrounding boards. The plurality of the surrounding boards are foldable to form a hollow tubular shape and connected. Two opposite ends of the tubular-shaped surrounding unit have two opposite connecting ends. The two buckling boards are disposed to a top end and a bottom end of the surrounding unit, respectively, and the two buckling boards are foldable with respect to the surrounding unit. The two buckling boards are folded towards a bottom surface and a top surface of the surrounding unit to be buckled to the two opposite connecting ends of the surrounding unit, so that the plurality of the surrounding boards are folded to form the hollow tubular shape, and an accommodating space is surrounded among the two buckling boards and the surrounding unit. An outer surface of the surrounding unit is equipped with a plurality of fastening elements. Each fastening element includes at least one protruding frame and at least one fastening groove. The plurality of the protruding frames and the plurality of the fastening grooves of the plurality of the fastening elements are arranged alternately to the surrounding unit, the at least two battery fastening structures are mutually buckled by virtue of the plurality of the protruding frames being buckled in the plurality of the fastening grooves.

As described above, the surrounding unit surrounds the battery for reaching an isolation function and a protecting function, the at least two battery fastening structures are flexibly buckled and combined with each other to form the battery fastening structure assemblies having different shapes, so the battery fastening structure assembly is capable of flexibly controlling a quantity of the batteries which are assembled in the battery fastening structure assembly, and the at least two battery fastening structures of the battery fastening structure assembly is capable of flexibly being assembled to appropriate for the at least two batteries forming different shapes. Furthermore, the battery fastening structures of the battery fastening structure assembly are mutually buckled by virtue of the plurality of the protruding frames being buckled in the plurality of the fastening grooves, so that the battery fastening structure assembly reaches a smaller volume for assembling and fastening the at least two batteries.

### BRIEF DESCRIPTION OF THE DRAWINGS

The present invention will be apparent to those skilled in the art by reading the following description, with reference to the attached drawings, in which:

FIG. 1 is a diagrammatic drawing of a battery fastening structure in accordance with the present invention;

FIG. 2 is an unfolded view of the battery fastening structure in accordance with the present invention;

FIG. 3 is a diagrammatic cross-section view of a surrounding unit of the battery fastening structure in accordance with the present invention;

FIG. 4 is a diagrammatic drawing showing the surrounding unit and two buckling boards buckled with two ends of the surround unit of the battery fastening structure in accordance with the present invention;

FIG. 5 is another diagrammatic section view of the battery fastening structure in accordance with the present invention;

FIG. 6 is a vertical view of a buckling board of the battery fastening structure in accordance with the present invention;

FIG. 7 is a diagrammatic section view showing the buckling board of the battery fastening structure in accordance with the present invention;

FIG. 8 is a diagrammatic drawing of the battery fastening structure in accordance with the present invention, wherein at least one nickel strip is fastened to the battery fastening structure through fastening recesses of the battery fastening structure;

FIG. 9 is a diagrammatic drawing showing a battery fastening structure assembly in accordance with a first preferred embodiment of the present invention, wherein the battery fastening structure assembly includes a plurality of the battery fastening structures mutually buckled;

FIG. 10 is another diagrammatic drawing showing the battery fastening structure assembly in accordance with a second preferred embodiment of the present invention, wherein the battery fastening structure assembly includes the plurality of the battery fastening structures mutually buckled; and

FIG. 11 is another diagrammatic drawing showing the battery fastening structure assembly in accordance with a third preferred embodiment of the present invention, wherein the battery fastening structure assembly includes the plurality of the battery fastening structures mutually buckled.

### DETAILED DESCRIPTION OF THE PREFERRED EMBODIMENT

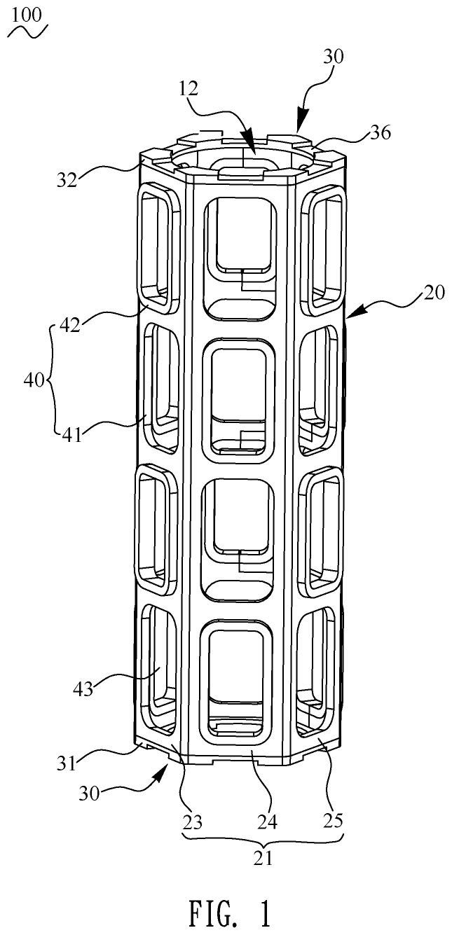

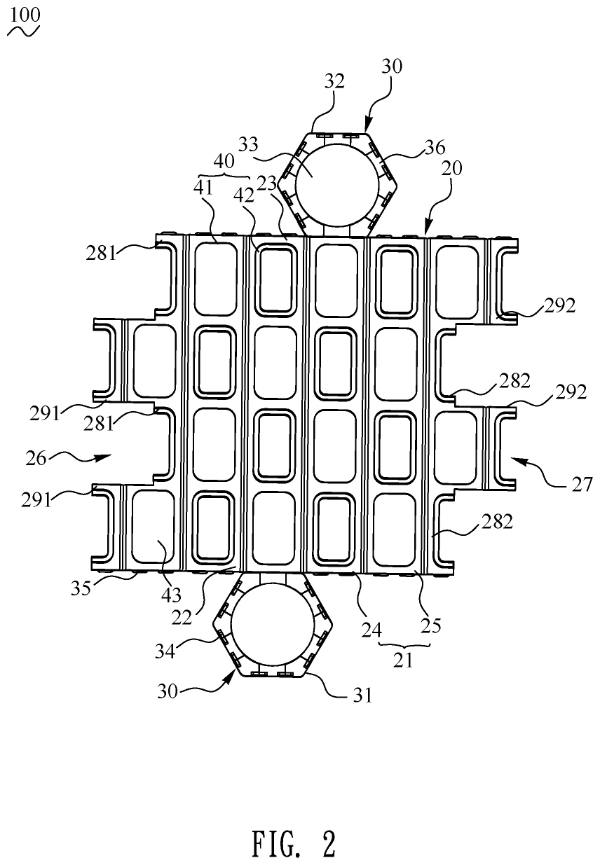

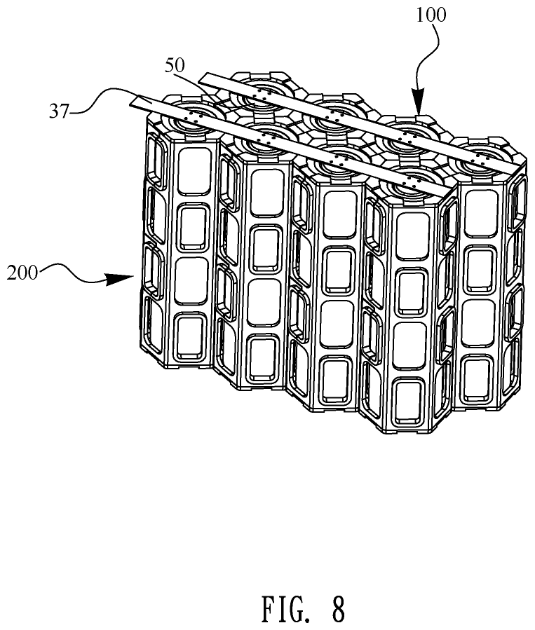

With reference to FIG. 1, FIG. 2 and FIG. 8, a battery fastening structure 100 and a battery fastening structure assembly 200 in accordance with the present invention are shown. The battery fastening structure assembly 200 includes at least two battery fastening structures 100 for fastening at least two batteries 50. Each battery fastening structure 100 adapted for surrounding a battery 50, includes a surrounding unit 20, a plurality of fastening elements 40 and two buckling boards 30.

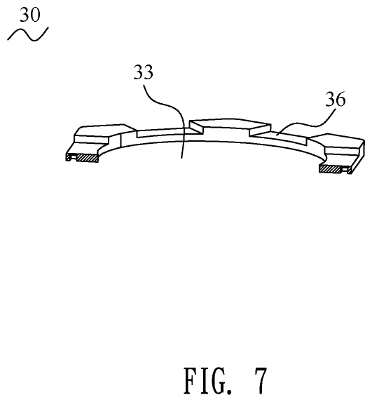

Referring to FIG. 2 to FIG. 8, the surrounding unit 20 is easily folded. The surrounding unit 20 includes a plurality of surrounding boards 21. The surrounding unit 20 includes four surrounding boards 21 which are easily folded, a first tenon board 26 and a second tenon board 27 located at two opposite sides of the surrounding unit 20. The plurality of the surrounding boards 21 are located between the first tenon board 26 and the second tenon board 27. An outer surface of the surrounding unit 20 is equipped with the plurality of the fastening elements 40. At least two surrounding units 20 of the at least two battery fastening structures 100 are buckled and integrated with each other by virtue of the plurality of the fastening elements 40 of the at least two surrounding units 20 of the at least two battery fastening structures 100 being fastened with each other. Each fastening element 40 includes at least one protruding frame 42 and at least one fastening groove 41. The at least one protruding frame 42 is able to be buckled with the at least one fastening groove 41. The at least one protruding frame 42 is of a rectangular frame shape and projects beyond the outer surface of the surrounding unit 20. The at least one fastening groove 41 is of a rectangular ring shape and is matched with the at least one protruding frame 42, so when the at least one protruding frame 42 is inserted into the at least one fastening groove 41, the at least one protruding frame 42 cooperates with the at least one fastening groove 41 tightly. The at least one fastening groove 41 is recessed inward from the outer surface of the surrounding unit 20 and penetrating through the outer surface of the surrounding unit 20. The surrounding unit 20 opens at least one dissipating hole 43 penetrating through the outer surface of the surrounding unit 20. The at least one dissipating hole 43 is of a rectangular shape, and the at least one dissipating hole 43 is surrounded by the at least one fastening groove 41 or disposed in a middle of the at least one protruding frame 42.

Each fastening element 40 includes a plurality of protruding frames 42 and a plurality of fastening grooves 41. The surrounding unit 20 opens a plurality of dissipating holes 43. The plurality of the dissipating holes 43 are of the rectangular shapes. The plurality of the dissipating holes 43 are surrounded by the plurality of the fastening grooves 41 and disposed in middles of the plurality of the protruding frames 42. The plurality of the protruding frames 42 and the plurality of the fastening grooves 41 of the plurality of the fastening elements 40 are arranged alternately to the surrounding unit 20. When the surrounding unit 20 is unfolded, the plurality of the protruding frames 42 and the plurality of the fastening grooves 41 are alternately arranged to the surrounding unit 20.

The plurality of the protruding frames 42 and the plurality of the fastening grooves 41 are arranged in a plurality of rows and along a vertical direction, and the plurality of the protruding frames 42 and the plurality of the fastening grooves 41 are arranged in a plurality of lines and in a transverse direction perpendicular to the vertical direction. When the surrounding unit 20 is folded to a hollow tubular shape, the plurality of the protruding frames 42 and the plurality of the fastening grooves 41 are arranged alternately to the surrounding unit 20. The plurality of the protruding frames 42 and the plurality of the fastening grooves 41 are arranged in the plurality of the rows and along the vertical direction, and the plurality of the protruding frames 42 and the plurality of the fastening grooves 41 are arranged in the plurality of the lines in the clockwise direction or the anticlockwise direction, so the at least two battery fastening structures 100 are mutually buckled with each other by virtue of a structural relationship of the plurality of the protruding frames 42 and the plurality of the fastening grooves 41.

Preferably, when the surrounding unit 20 is unfolded, each surrounding board 21 has two protruding frames 42 and two fastening grooves 41 alternately disposed in four rows and along the vertical direction, and tops of the four surrounding units 20 have two protruding frames 42 and two fastening grooves 41 alternately disposed in four lines and along the clockwise direction or the anticlockwise direction.

When the surrounding unit 20 surrounds the battery 50, the surrounding unit 20 is folded to the hollow tubular shape, in each surrounding board 21, one fastening groove 41 and one protruding frame 42 is located at an upper end and a lower end of the surrounding board 21, and the other fastening groove 41 and the other protruding frame 42 are adjacent to each other and located between the one fastening groove 41 and the one protruding frame 42. The surrounding unit 20 has sixth lines of the protruding frames 42 and the fastening grooves 41 along the vertical direction, and four aligned layers of the protruding frames 42 and the fastening grooves 41 along the clockwise direction or the anticlockwise direction. Each layer of the surrounding unit 20 has three protruding frames 42 and three fastening grooves 41 alternately disposed in the clockwise direction or the anticlockwise direction. Each two fastening grooves 41 of each layer of the surrounding unit 20 are spaced by one protruding frame 42.

The plurality of the surrounding boards 21 are foldable to form a hollow tubular shape and connected. The four surrounding boards 21 are foldable and connected. When the surrounding unit 20 is unfolded, the first tenon board 26 and the second tenon board 27 are connected with two opposite sides of the four surrounding boards 21, respectively. An outer side of the first tenon board 26 away from the four surrounding boards 21 has two lying U-shaped first lacking grooves 281 and two lying U-shaped first protruding portions 291 arranged alternately. Specifically, in the first tenon board 26, one first lacking groove 281 and one first protruding portion 291 are located at an upper portion and a lower portion of the first tenon board 26, and the other first lacking groove 281 and the other first protruding portion 291 of the first tenon board 26 are adjacent to each other, and located between the one first lacking groove 281 and the one first protruding portion 291. A mouth of each first lacking groove 281 faces outward, and a mouth of each first protruding portion 291 faces outward.

The first tenon board 26 is matched with the second tenon board 27. The second tenon board 27 cooperates with the first tenon board 26. The second tenon board 27 has two second lacking grooves 282 corresponding to the two first lacking grooves 281, and two second protruding portions 292 corresponding to the two first protruding portions 291. The two second lacking grooves 282 and the two second protruding portions 292 are arranged alternately. Arranging positions of the two second lacking grooves 282 are corresponding to arranging positions of the two first lacking grooves 281, and arranging positions of the two second protruding portions 292 are corresponding to arranging positions of the two first protruding portions 291. In the second tenon board 27, one second lacking groove 282 and one second protruding portion 292 are located at an upper portion and a lower portion of the second tenon board 27, and the other second lacking groove 282 and the other second protruding portion 292 of the second tenon board 27 are adjacent to each other, and located between the one second lacking groove 282 and the one second protruding portion 292. Preferably, in the first tenon board 26, the one first lacking groove 281, the one first protruding portion 291, the other first lacking groove 281 and the other first protruding portion 291 of the first tenon board 26 are arranged in sequence and in an up-down direction. In the second tenon board 27, the one second protruding portion 292, the one second lacking groove 282, the other second protruding portion 292 and the other second lacking groove 282 of the second tenon board 27 are arranged in sequence and in the up-down direction. When the surrounding unit 20 is folded to the hollow tubular shape, the first tenon board 26 and the second tenon board 27 are connected with each other.

The four surrounding boards 21 includes a first surrounding board 22, a second surrounding board 23, a third surrounding board 24 and a fourth surrounding board 25 arranged in sequence. The first surrounding board 22, the second surrounding board 23, the third surrounding board 24 and the fourth surrounding board 25 have a same size and a same shape. Two of the first surrounding board 22, the second surrounding board 23, the third surrounding board 24 and the fourth surrounding board 25 are connected and foldable, so that the surrounding unit 20 is capable of being folded to from a hexagonal hollow tubular shape. The tubular-shaped surrounding unit 20 maintains a fixation status by virtue of the first tenon board 26 being buckled with and combined with the second tenon board 27, and the first tenon board 26 and the second tenon board 27 are combined without needing a help of other tools, such as pinch pliers or screwdrivers. The first tenon board 26 and the second tenon board 27 just need be mutually buckled and fastened with each other by hand.

Referring to FIG. 2, the two buckling boards 30 are disposed to a top end and a bottom end of the surrounding unit 20, respectively, and the two buckling boards 30 are foldable with respect to the surrounding unit 20. The two buckling boards 30 include a first buckling board 31 and a second buckling board 32 which have a same size and a same shape. The first buckling board 31 is of a hexagonal shape. One side of the first buckling board 31 is connected with an edge of a bottom end of the second surrounding board 23, and the first buckling board 31 is disposed to the bottom end of the second surrounding board 23 and is capable of being folded with respect to the second surrounding board 23, so that the one side of the first buckling board 31 covers a bottom surface of the second surrounding board 23. The second buckling board 32 is of the hexagonal shape. One side of the second buckling board 32 is connected with an edge of a top end of the third surrounding board 24, and the second buckling board 32 is disposed to the top end of the third surrounding board 24 and is capable of being folded with respect to the third surrounding board 24, so that the one side of the second buckling board 32 covers a top surface of the third surrounding board 24.

A middle of each buckling board 30 opens a circular penetrating hole 33. Each buckling board 30 opens at least one limiting hole 34. Preferably, the two buckling boards 30 open a plurality of rectangular limiting holes 34. The first buckling board 31 opens ten rectangular limiting holes 34 in a surface of the first buckling board 31 connected with the bottom surface of the second surrounding board 23 at the time of the first buckling board 31 being folded towards the bottom surface of the second surrounding board 23. The second buckling board 32 opens ten rectangular limiting holes 34 in a surface of the second buckling board 32 connected with the top surface of the third surrounding board 24 at the time of the second buckling board 32 being folded towards the top surface of the third surrounding board 24. When the surrounding unit 20 is folded to the hollow tubular shape and the two buckling boards 30 are folded towards the tubular-shaped surrounding unit 20, the plurality of the limiting holes 34 are disposed in surfaces of the two buckling boards 30 connected with the tubular-shaped surrounding unit 20.

Two limiting holes 34 are defined as a group of the limiting holes 34. The plurality of the limiting holes 34 of the two buckling boards 30 are divided into a plurality groups of the limiting holes 34. The plurality of the limiting holes 34 which are divided into the plurality groups of the limiting holes 34 are distributed in peripheries of the two buckling boards 30 around the two penetrating holes 33 of the two buckling boards 30. The ten limiting holes 34 of the first buckling board 31 are divided into five groups of the limiting holes 34. The five groups of the limiting holes 34 are distributed in five sides of the first buckling board 31 disconnected with the second surrounding board 23. The ten limiting holes 34 of the second buckling board 32 are divided into five groups of the limiting holes 34. The five groups of the limiting holes 34 are distributed in five sides of the second buckling board 32 disconnected with the third surrounding board 24. Long side walls of the plurality of the limiting holes 34 of the two buckling boards 30 are parallel with edges of the five sides of the first buckling board 31.

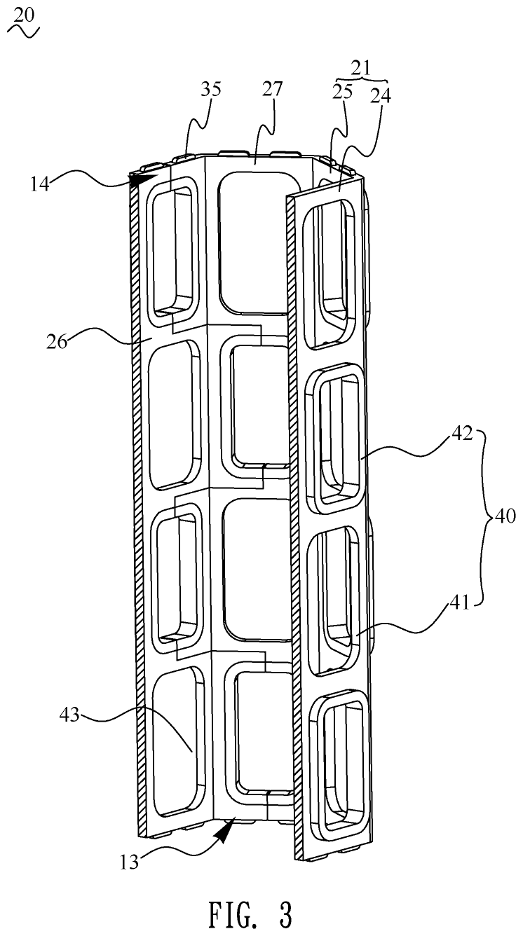

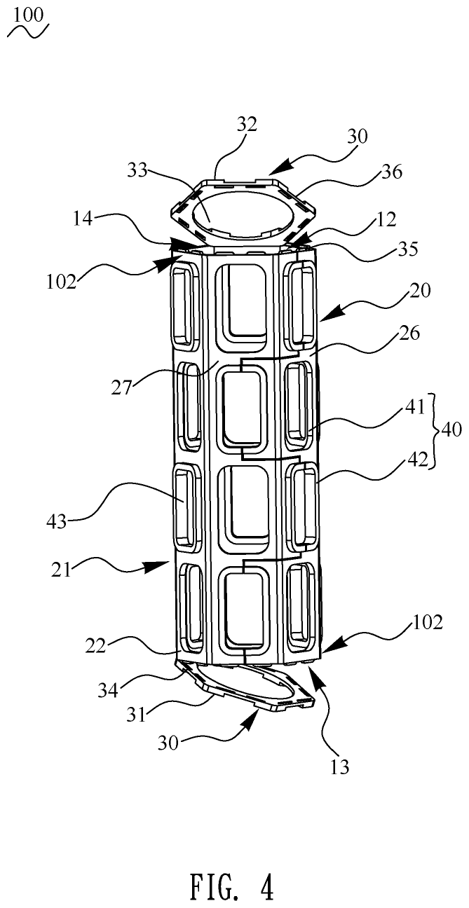

Referring to FIG. 3 and FIG. 4, two opposite ends of the tubular-shaped surrounding unit 20 have two opposite connecting ends 102. The two opposite ends of the tubular-shaped surrounding unit 20 have a first connecting end 13 and a second connecting end 14, respectively. The two opposite connecting ends 201 include the first connecting end 13 and the second connecting end 14. The top end of the surrounding unit 20 has at least one limiting block 35, and the bottom end of the surrounding unit 20 has at least one limiting block 35. The at least one limiting block 35 is matched with and limited in the at least one limiting hole 34. The top end and the bottom end of the surrounding unit 20 have a plurality of limiting blocks 35. Preferably, ten portions of the top end and ten portions of the bottom end of the surrounding unit 20 protrude oppositely to form ten rectangular limiting blocks 35 located on the top end of the surrounding unit 20, and ten rectangular limiting blocks 35 located at the bottom end of the surrounding unit 20. The plurality of the limiting blocks 35 are divided into ten groups of the limiting blocks 35. The ten groups of the limiting blocks 35 are located on a top end and a bottom end of the first surrounding board 22, a top end and a bottom end of the fourth surrounding board 25, a top end of the second surrounding board 23, a bottom end of the third surrounding board 24, top ends of the first tenon board 26 and the second tenon board 27, and bottom ends of the first tenon board 26 and the second tenon board 27.

Long sides of the plurality of the limiting blocks 35 are parallel with a top edge and a bottom edge of the surrounding unit 20, namely the long sides of the plurality of the limiting blocks 35 are parallel with top edges and bottom edges of the first surrounding board 22, the second surrounding board 23, the third surrounding board 24, the fourth surrounding board 25, the first tenon board 26 and the second tenon board 27. The plurality of the limiting blocks 35 are distributed on the top end of the surrounding unit 20 and distributed at the bottom end of the surrounding unit 20. The two buckling boards 30 are folded towards a bottom surface and a top surface of the surrounding unit 20 to be buckled to the two opposite connecting ends 102 of the surrounding unit 20, so that the plurality of the surrounding boards 21 are folded to form the hollow tubular shape, and an accommodating space 12 is surrounded among the two buckling boards 30 and the surrounding unit 20. The at least one dissipating hole 43 is communicated between the accommodating space 12 and an outside. The two buckling boards 30 are buckled to and fastened to the two opposite connecting ends 102 of the hollow tubular-shaped surrounding unit 20 by virtue of the plurality of the limiting blocks 35 being limited in the plurality of the limiting holes 34. After the first buckling board 31 and the second buckling board 32 are folded towards the bottom surface and the top surface of the surrounding unit 20, respectively, the first buckling board 31 and the second buckling board 32 of the battery fastening structure 100 are buckled to the first connecting end 13 and the second connecting end 14, respectively by virtue of the plurality of the limiting blocks 35 being limited in the plurality of limiting holes 34, so that the accommodating space 12 is surrounded among the first buckling board 31, the second buckling board 32 and the surrounding unit 20.

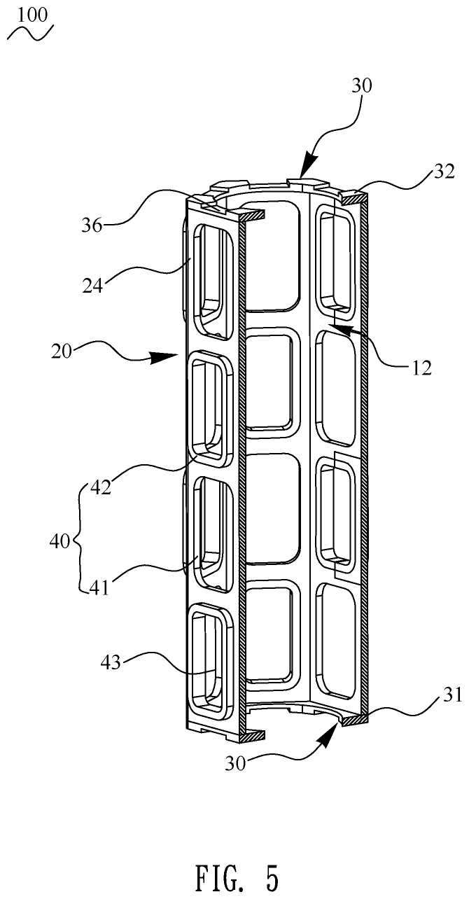

Referring to FIG. 4, FIG. 5 and FIG. 8, at the moment, the accommodating space 12 is communicated with the two penetrating holes 33 of the two buckling boards 30. After the battery 50 is placed in the accommodating space 12 of the surrounding unit 20, the two buckling boards 30 covers the bottom surface and the top surface of the surrounding unit 20, respectively for blocking the battery 50 from being fallen off. The accommodating space 12 is used for fastening the battery 50, heat generated in an operation process of the battery 50 is dissipated through the plurality of the dissipating holes 43.

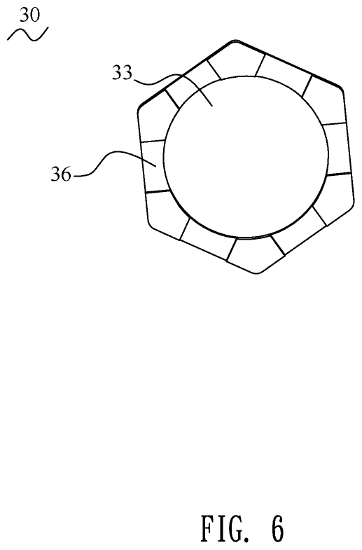

Referring to FIG. 6 to FIG. 8, when the two buckling boards 30 are buckled to the folded surrounding unit 20, outer surfaces of the two buckling boards 30 are exposed outside. Several portions of the outer surfaces of the two buckling boards 30 are recessed inward towards the accommodating space 12 to form a plurality of recesses 36 disposed around peripheries of the outer surfaces of the two buckling boards 30 which are exposed outside, respectively. Six portions of the outer surface of each buckling board 30 are recessed inward towards the accommodating space 12 to form six recesses 36. The six recesses 36 are disposed in middles of outer surfaces of six sides of each buckling board 30, respectively, so the outer surfaces of the two buckling boards 30 are shown as concave-convex structures for facilitating at least two surrounding units 20 of the at least two battery fastening structures 100 being buckled with each other. When the at least two battery fastening structures 100 are combined in series or in parallel, a nickel strip 37 is flexibly fastened to at least two outer surfaces of the at least two buckling boards 30 of the at least two battery fastening structures 100 by virtue of the nickel strip 37 being received in at least four recesses 36 of the at least two buckling boards 30 of the at least two battery fastening structures 100 of the battery fastening structure assemblies 200. The nickel strip 37 is used for being spot soldered.

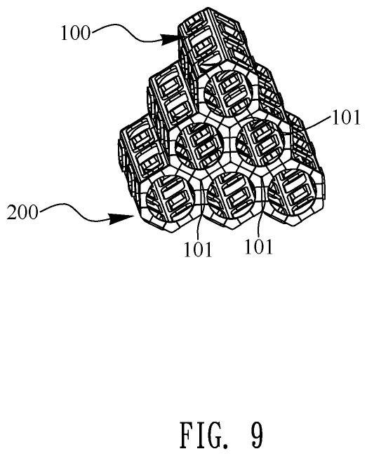

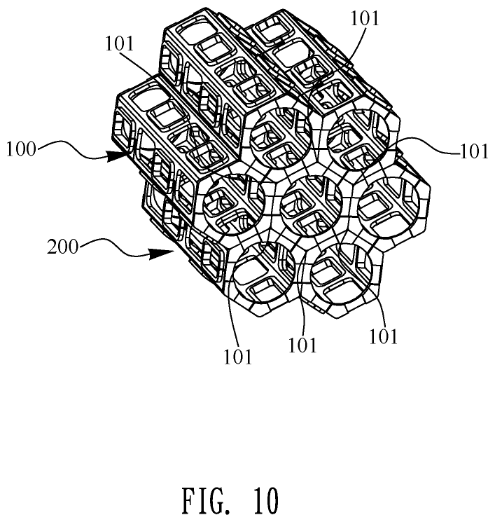

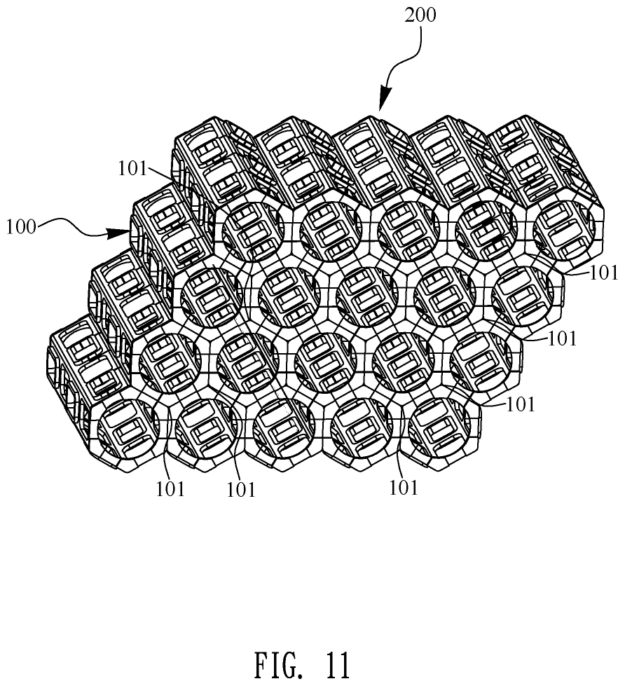

Referring to FIG. 2, FIG. 9, FIG. 10 and FIG. 11, the surrounding unit 20 is integrally molded with the two buckling boards 30. The plurality of the dissipating holes 43 are disposed in the four surrounding boards 21, the first tenon board 26 and the second tenon board 27. When the surrounding unit 20 is folded to the hollow tubular shape, the plurality of the dissipating holes 43 are distributed in six walls of the tubular-shaped surrounding unit 20, namely the first surrounding board 22, the second surrounding board 23, the third surrounding board 24, the fourth surrounding board 25, the first tenon board 26 and the second tenon board 27, so that when one wall of the tubular-shaped surrounding unit 20 of one battery fastening structure 100 is buckled with the surrounding unit 20 of another battery fastening structure 100, a dissipating function of the battery fastening structures 100 will be without being affected.

Referring to FIG. 1 to FIG. 11, in use, the battery fastening structure 100 is shown as the hollow tubular shape. The at least two battery fastening structures 100 are flexibly buckled and combined with each other to form the battery fastening structure assemblies 200 having different shapes, and each battery fastening structure assembly 200 is one of triangle shapes, parallelograms and column shapes. The battery fastening structure assembly 200 is shown as a honeycomb shape seen from a front view. Two adjacent spaced sides of each two adjacent battery fastening structures 100 forms an interval 101 between the two adjacent spaced sides of each two adjacent battery fastening structures 100. The at least two battery fastening structures 100 of the battery fastening structure assembly 200 are mutually buckled by virtue of the plurality of the protruding frames 42 being buckled in the plurality of the fastening grooves 41.

The battery fastening structure assembly 200 in accordance with a first preferred embodiment of the present invention is shown in FIG. 9. The battery fastening structure assembly 200 in accordance with the first preferred embodiment is shown as a triangle shape. In the first preferred embodiment, the triangle-shaped battery fastening structure assembly 200 includes three layers of battery fastening structures 100 which are a bottom layer of the battery fastening structure assembly 200, a middle layer of the battery fastening structure assembly 200, and a top layer of the battery fastening structure assembly 200. The bottom layer of the battery fastening structure assembly 200 includes three battery fastening structures 100, the middle layer of the battery fastening structure assembly 200 includes two battery fastening structures 100 positioned on a middle of the bottom layer of the battery fastening structure assembly 200, and the top layer of the battery fastening structure assembly 200 includes one battery fastening structure 100. The two battery fastening structures 100 of the middle layer of the battery fastening structure assembly 200 are positioned in two intervals 101 of the bottom layer of the battery fastening structure assembly 200, the battery fastening structure 100 of the top layer of the battery fastening structure assembly 200 is positioned in the interval 101 of the middle layer of the battery fastening structure assembly 200.

The battery fastening structure assembly 200 in accordance with a second preferred embodiment of the present invention is shown in FIG. 10. The battery fastening structure assembly 200 in accordance with the second preferred embodiment is shown as a column shape. The battery fastening structure assembly 200 in accordance with the second preferred embodiment includes seven battery fastening structures 100. In the second preferred embodiment, one battery fastening structure 100 is disposed among and surrounded by six connected battery fastening structures 100 to form the column shape. The one battery fastening structure 100 is received in the intervals 101 among the six battery fastening structures 100.

The battery fastening structure assembly 200 in accordance with a third preferred embodiment of the present invention is shown in FIG. 11. The battery fastening structure assembly 200 in accordance with the third preferred embodiment is shown as a parallelogram. The battery fastening structure assembly 200 in accordance with the third preferred embodiment includes twenty battery fastening structures 100 arranged in four layers. Each layer of the battery fastening structure assembly 200 includes five connected battery fastening structures 100. The battery fastening structure 100 of each layer of the battery fastening structure assembly 200 is positioned in the intervals 101 among the twenty battery fastening structures 100 of the battery fastening structure assembly 200 in accordance with the third preferred embodiment of the present invention. The battery fastening structures 100 of each layer of the battery fastening structure assembly 200 are parallel with the battery fastening structures 100 of other layers of the battery fastening structure assembly 200.

The at least two battery fastening structures 100 of the battery fastening structure assembly 200 is capable of flexibly being assembled to appropriate for the at least two batteries 50 forming the different shapes. The battery fastening structure 100 of the battery fastening structure assembly 200 is without needing to redesign and manufacture another battery supporting structure for fastening the at least two batteries 50 forming the different shapes. Each battery 50 is a 18650 type lithium battery.

As described above, the surrounding unit 20 surrounds the battery 50 for reaching an isolation function and a protecting function, the at least two battery fastening structures 100 are flexibly buckled and combined with each other to form the battery fastening structure assemblies 200 having different shapes, so the battery fastening structure assembly 200 is capable of flexibly controlling a quantity of the batteries 50 which are assembled in the battery fastening structure assembly 200, and the at least two battery fastening structures 100 of the battery fastening structure assembly 200 is capable of flexibly being assembled to appropriate for the at least two batteries 50 forming the different shapes. Furthermore, the battery fastening structures 100 of the battery fastening structure assembly 200 are mutually buckled by virtue of the plurality of the protruding frames 42 being buckled in the plurality of the fastening grooves 41, so that the battery fastening structure assembly 200 reaches a smaller volume for assembling and fastening the at least two batteries 50.

What is claimed is:

1. A battery fastening structure, comprising:
a surrounding unit including a plurality of surrounding boards, the plurality of the surrounding boards being foldable to form a hollow tubular shape and connected, two opposite ends of the tubular-shaped surrounding unit having two opposite connecting ends; and
two buckling boards disposed to a top end and a bottom end of the surrounding unit, respectively, and the two buckling boards being foldable with respect to the surrounding unit, the two buckling boards being folded towards a bottom surface and a top surface of the surrounding unit to be buckled to the two connecting ends of the surrounding unit, so that the plurality of the surrounding boards being folded to form the hollow tubular shape, and an accommodating space being surrounded among the two buckling boards and the surrounding unit, an outer surface of the surrounding unit being equipped with a plurality of fastening elements, at least two surrounding units being buckled and integrated with each other by virtue of the plurality of the fastening elements of the at least two surrounding units being fastened with each other.

2. The battery fastening structure as claimed in claim 1, wherein the surrounding unit includes a first tenon board and a second tenon board located at two opposite sides of the surrounding unit, the plurality of the surrounding boards are located between the first tenon board and the second tenon board, the tubular-shaped surrounding unit maintains a fixation status by virtue of the first tenon board being buckled with and combined with the second tenon board.

3. The battery fastening structure as claimed in claim 1, wherein each fastening element includes at least one protruding frame and at least one fastening groove, the plurality of the protruding frames and the plurality of the fastening grooves of the plurality of the fastening elements are arranged alternately to the surrounding unit, the at least one protruding frame is able to be buckled with the at least one fastening groove.

4. The battery fastening structure as claimed in claim 3, wherein the surrounding unit opens at least one dissipating hole penetrating through the outer surface of the surrounding unit, the at least one dissipating hole is communicated between the accommodating space and an outside.

5. The battery fastening structure as claimed in claim 4, wherein the at least one dissipating hole is surrounded by the at least one fastening groove.

6. The battery fastening structure as claimed in claim 4, wherein the at least one dissipating hole is disposed in a middle of the at least one protruding frame.

7. The battery fastening structure as claimed in claim 4, wherein the at least one dissipating hole is of a rectangular shape.

8. The battery fastening structure as claimed in claim 1, wherein each buckling board opens at least one limiting hole, the top end of the surrounding unit has at least one limiting block, and the bottom end of the surrounding unit has at least one limiting block, the at least one limiting block is matched with and limited in the at least one limiting hole.

9. The battery fastening structure as claimed in claim 1, wherein a middle of each buckling board opens a circular penetrating hole, the two buckling boards open a plurality of limiting holes disposed in surfaces of the two buckling boards connected with the tubular-shaped surrounding unit, the plurality of the limiting holes are distributed in peripheries of the two buckling boards around the two penetrating holes of the two buckling boards, the top end and the bottom end of the surrounding unit have a plurality of limiting blocks, the two buckling boards are buckled to and fastened to the two opposite connecting ends of the hollow tubular-shaped surrounding unit by virtue of the plurality of the limiting blocks being limited in the plurality of the limiting holes, at the moment, the accommodating space is communicated with the two penetrating holes of the two buckling boards.

10. The battery fastening structure as claimed in claim 1, wherein several portions of outer surfaces of the two buckling boards are recessed inward towards the accommodating space to form a plurality of recesses disposed around peripheries of the outer surfaces of the two buckling boards which are exposed outside, respectively, when at least two battery fastening structures are combined in series, a nickel strip is flexibly fastened to at least two outer surfaces of at least two buckling boards of the at least two battery fastening structures by virtue of the nickel strip being received in at least four recesses of the at least two buckling boards of the at least two battery fastening structures.

11. The battery fastening structure as claimed in claim 10, wherein when the at least two battery fastening structures are combined in parallel, the nickel strip is flexibly fastened to the at least two outer surfaces of the at least two buckling boards of the at least two battery fastening structures by virtue of the nickel strip being received in the at least four recesses of the at least two buckling boards of the at least two battery fastening structures.

12. A battery fastening structure assembly, comprising:
at least two battery fastening structures for fastening at least two batteries, each battery fastening structure including:
a surrounding unit including a plurality of surrounding boards, the plurality of the surrounding boards being foldable to form a hollow tubular shape and connected, two opposite ends of the tubular-shaped surrounding unit having two opposite connecting ends; and
two buckling boards disposed to a top end and a bottom end of the surrounding unit, respectively, and the two buckling boards being foldable with respect to the surrounding unit, the two buckling boards being folded towards a bottom surface and a top surface of the surrounding unit to be buckled to the two connecting ends of the surrounding unit, so that the plurality of the surrounding boards being folded to form the hollow tubular shape, and an accommodating space being surrounded among the two buckling boards and the surrounding unit, an outer surface of the surrounding unit being equipped with a plurality of fastening elements, at least two surrounding units of the at least two battery fastening structures being buckled and integrated with each other by virtue of the plurality of the fastening elements of the at least two surrounding units of the at least two battery fastening structures being fastened with each other.

13. The battery fastening structure assembly as claimed in claim 12, wherein the surrounding unit includes a first tenon board and a second tenon board located at two opposite sides of the surrounding unit, the plurality of the surrounding boards are located between the first tenon board and the second tenon board, the tubular-shaped surrounding unit maintains a fixation status by virtue of the first tenon board being buckled with and combined with the second tenon board.

14. The battery fastening structure assembly as claimed in claim 12, wherein each fastening element includes at least one protruding frame and at least one fastening groove, the plurality of the protruding frames and the plurality of the fastening grooves of the plurality of the fastening elements are arranged alternately to the surrounding unit, the at least one protruding frame is able to be buckled with the at least one fastening groove.

15. The battery fastening structure assembly as claimed in claim 14, wherein the surrounding unit opens a plurality of dissipating holes of rectangular shapes, the plurality of the dissipating holes are surrounded by the plurality of the fastening grooves and disposed in middles of the plurality of the protruding frames.

16. The battery fastening structure assembly as claimed in claim 12, wherein a middle of each buckling board opens a circular penetrating hole, the two buckling boards open a plurality of limiting holes disposed in surfaces of the two buckling boards connected with the tubular-shaped surrounding unit, the plurality of the limiting holes are distributed in peripheries of the two buckling boards around the two penetrating holes of the two buckling boards, the top end and the bottom end of the surrounding unit have a plurality of limiting blocks, the two buckling boards are buckled to and fastened to the two opposite connecting ends of the hollow tubular-shaped surrounding unit by virtue of the plurality of the limiting blocks being limited in the plurality of the limiting holes, at the moment, the accommodating space is communicated with the two penetrating holes of the two buckling boards.

17. The battery fastening structure assembly as claimed in claim 12, wherein several portions of outer surfaces of the two buckling boards are recessed inward towards the accommodating space to form a plurality of recesses disposed around peripheries of the outer surfaces of the two buckling boards which are exposed outside, respectively, when at least two battery fastening structures are combined in series, a nickel strip is flexibly fastened to at least two outer surfaces of at least two buckling boards of the at least two battery fastening structures by virtue of the nickel strip being received in at least four recesses of the at least two buckling boards of the at least two battery fastening structures, when the at least two battery fastening structures are combined in parallel, the nickel strip is flexibly fastened to the at least two outer surfaces of the at least two buckling boards of the at least two battery fastening structures by virtue of the nickel strip being received in the at least four recesses of the at least two buckling boards of the at least two battery fastening structures.

18. The battery fastening structure assembly as claimed in claim 12, wherein the at least two battery fastening structures are flexibly buckled and combined with each other to form the battery fastening structure assemblies having different shapes, and each battery fastening structure assembly is one of triangle shapes, parallelograms and column shapes.

19. A battery fastening structure assembly, comprising:
at least two battery fastening structures for fastening at least two batteries, each battery fastening structure including:
a surrounding unit including a plurality of surrounding boards, the plurality of the surrounding boards being foldable to form a hollow tubular shape and connected, two opposite ends of the tubular-shaped surrounding unit having two opposite connecting ends; and
two buckling boards disposed to a top end and a bottom end of the surrounding unit, respectively, and the two buckling boards being foldable with respect to the surrounding unit, the two buckling boards being folded towards a bottom surface and a top surface of the surrounding unit to be buckled to the two connecting ends of the surrounding unit, so that the plurality of the surrounding boards being folded to form the hollow tubular shape, and an accommodating space being surrounded among the two buckling boards and the surrounding unit, an outer surface of the surrounding unit being equipped with a plurality of fastening elements, each fastening element including at least one protruding frame and at least one fastening groove, the plurality of the protruding frames and the plurality of the fastening grooves of the plurality of the fastening elements being arranged alternately to the surrounding unit, the at least two battery fastening structures being mutually buckled by virtue of the plurality of the protruding frames being buckled in the plurality of the fastening grooves.

20. The battery fastening structure assembly as claimed in claim 19, wherein the at least two battery fastening structures are flexibly buckled and combined with each other to form the battery fastening structure assemblies having different shapes, and each battery fastening structure assembly is one of triangle shapes, parallelograms and column shapes.
